(19) United States
(12) Patent Application Publication
(10) Pub. No.: US 2014/0308513 A1
(43) Pub. Date: Oct. 16, 2014

(54) NOBLE METAL PROTECTIVE FILM AND METHOD OF FORMING THE SAME

(71) Applicant: JEWELRY MIURA CO., LTD., Tokyo (JP)

(72) Inventor: Toshinori Miura, Tokyo (JP)

(73) Assignee: JEWELRY MIURA CO., LTD., Tokyo (JP)

(21) Appl. No.: 14/317,833

(22) Filed: Jun. 27, 2014

Related U.S. Application Data
(63) Continuation of application No. PCT/JP2012/083537, filed on Dec. 25, 2012.

(30) Foreign Application Priority Data
Dec. 27, 2011 (JP) 2011-286475
May 8, 2012 (JP) 2012-107064

(51) Int. Cl. C23D 5/02; B05D 3/02; B05D 1/18

(52) U.S. Cl. CPC C23D 5/02; B05D 1/18; B05D 3/0218
USPC 428/336; 427/318

(57) ABSTRACT

Forming a strong and dense protective film with excellent adhesion to a noble metal base and includes a level of durability that would allow it to be frequently worn without paying particular attention to handling in daily life, and easily forming a protective film on the surface of a noble metal base which has excellent corrosion resistance, and where these effects are present over a long period of time. The noble metal protective film related to the present invention is a silica glass film having a film thickness of 0.2 μm to 1.0 μm formed by coating a composition for forming a glass film with polysilazane as the main component on a surface of a noble metal base, and holding the noble metal under a temperature less than the melting point of a noble metal base coated with the composition for forming a glass film in an atmosphere containing water vapor.

### CROSS REFERENCE TO RELATED APPLICATIONS

This application is based upon and claims the benefit of priority from the prior Japanese Patent Application No. 2011-286475, filed on Dec. 27, 2011, Japanese Patent Application No. 2012-107064 filed on May 8, 2012 and International Patent Application No. PCT/JP2012/083537 filed on Dec. 25, 2012, the entire contents of which are incorporated herein by reference.

### FIELD

The present invention is related to a film which protects a surface state of noble metal which easily changes color, for example, a silver-based alloy, “purple gold” containing aluminum and gold as the main component (hereinafter abbreviated to “Au—Al alloy”) and more specifically the present invention is related to forming a silica glass film which has excellent protective characteristics of a surface-state of the noble metal and a method for forming the silica glass film.

### BACKGROUND

Conventionally, gold or silver is often used as noble metal alloys used as ornaments, however, other than these an Au—Al alloy particularly forms a clean alloy when purple is exposed. Because alloys substantially having the color purple have a high decorative value, not only are they used as bullion jewelry, but the alloy itself is expected to be used as ornaments.

Therefore, using alloys having this purple color, the so-called purple gold, and manufacturing various decorative materials having a high decorative value is being demanded in terms of increasing decorative value or imparting unique impressions. A purple gold alloy and manufacturing method of the same is disclosed for example in International Publication WO2010/067422 (Patent Document 1) in order to solve this problem.

However, the alloy for jewelry described above changes color due to a reaction with gas molecules present in the air. For example, silver exposed to air reacts easily with sulfur dioxide in the air and a black film made from silver sulfide is formed. Therefore, the luster of the surface of an alloy containing silver is likely to be lost.

In addition, when aluminum in the surface of a noble metal alloy such as the Au—Al-based alloy described above is touched with a hand, the surface dissolves due to sweat or the proportion of dissolved metal parts and aluminum changes which makes it easy for discoloration. Therefore, in order to solve this problem Japanese Laid Open Patent H11-200013 (Patent Document 2) discloses a method for forming a transparent protective film having durability, which does not change color and has a high hardness.

However, because the transparent protective film disclosed in Patent Document 2 is formed from a first layer comprised from aluminum oxide and a second layer comprised of silica and because these layers are restricted by being formed using an ion plating method, there is a limit to expansion of the scale of production and simplification of production equipment. In addition, the transparent protective film disclosed in Patent Document 2 has a problem in that tends to peel off easily.

In Japanese Laid Open Patent 2006-007444 (Patent Document 3), Japanese Laid Open Patent 2008-528328 (Patent Document 4) and Japanese Laid Open Patent 2009-224536 (Patent Document 5) an invention is disclosed wherein a polysilazane solution is applied to the surface of gold or silver and this is added to a silica coating by hydrolysis. However, the polysilazane solution is merely applied to the surface of a base. Therefore, the polysilazane solution begins to react with water vapor in the air from the moment it is applied to a metal surface and it is difficult to form a thin uniform coating film.

### SUMMARY

Thus, in view of the actual situation of the conventional technology described above, one of the object of the present invention is forming a strong and dense protective film which has excellent adhesion to a noble metal base and includes a level of durability that would allow it to be frequently worn without paying particular attention to handling in daily life, and easily forming a protective film on the surface of a noble metal base which has excellent corrosion resistance, and where these effects are present over a long period.

In addition, since an alloy having the purple color described above has the fatal defect of being easily discolored by sweat and since the technology for overcoming this defect is insufficient, the alloy is not widely used despite being well-known from relatively a long time ago that it is extremely decorative. Therefore, the present invention dramatically improves the utility of a noble metal alloy as an ornament which includes a silver-based alloy as the noble metal base and purple gold such as an Au—Al alloy, and to promote widespread use.

A noble metal protective film related to the present invention includes coating a composition for forming a liquid glass film containing polysilazane as a main component on a surface of a noble metal base, and a noble metal protective film comprised from a silica glass film having a film thickness of 0.2 μm to 1.0 μm formed on a surface of the noble metal base by hydrolysis of a coating film comprised from the composition for forming a glass film in silicon dioxide, wherein the composition for forming a glass film does not include a catalyst component which converts polysilazane to silica glass and contains polysilazane in the range of 30 wt % to 42 wt % of the, the noble metal base is an Au—Al alloy containing gold and aluminum, with gold in the range of 78 wt % to 80 wt % and aluminum 18 wt % to 21 wt % and the silica glass film has a Vickers hardness of 328.7 (HV) or more.

A method of forming a noble metal protective film related to the present invention includes coating a liquid composition for forming a glass film containing polysilazane as a main component on a surface of a noble metal base in an inert gas atmosphere, and holding the noble metal base under a temperature less than the melting point of a noble metal base formed with a coating film comprised from the composition for forming a glass film, and forming a silica glass film having a film thickness of 0.2 μm to 1.0 μm, wherein the composition for forming a glass film does not include a catalyst component which converts polysilazane to silica glass and contains the polysilazane in the range of 30 wt % to 42 wt % , the noble metal base is an Au—Al alloy containing gold and aluminum with gold in the range of 78 wt % to 80 wt % and aluminum in the range of 18 wt % to 21 wt %, the holding temperature is 350° C. or less, and the silica glass film has a Vickers hardness of 328.7 (HV) or more.

In addition, in the structure described above, it is possible to form the noble metal protective film related to the present invention by coating the composition for forming a glass film on the surface of the noble metal base in an inert gas atmosphere.

In addition, in the structure described above, it is possible to form the noble metal protective film related to the present invention by holding the noble metal base formed with a coating layer comprised from the composition for forming a glass film in an atmosphere containing water vapor.

In addition, in the structure described above, it is possible to form the noble metal protective film related to the present invention by using argon gas as the inert gas.

In addition, in the structure described above, it is possible to form the noble metal protective film related to the present invention by coating the composition for forming a glass film on the Au—Al alloy by dipping a surface of an ornament comprised from the Au—Al alloy in the liquid composition for forming a glass film.

In addition, in the structure described above, it is possible to form the noble metal protective film related to the present invention by performing hydrolysis of the coating film in silicon dioxide by holding the noble metal base under a temperature less than the melting point of a noble metal base formed with a coating film comprised from the composition for forming a glass film.

In addition, in the structure described above, it is possible to form the noble metal protective film related to the present invention by setting the holding temperature to 350° C. or less.

### BRIEF DESCRIPTION OF THE DRAWINGS

FIG. 1 is a graph which shows the measurement result of Martens hardness (HM) of the surface of Example 5 and Reference example 6;

FIG. 2 is a graph which shows the measurement result of Vickers hardness (HV) of the surface of Example 5 and Reference Example 6;

FIG. 3 is a graph which shows the relationship between load (mN) and the indentation depth when the tip of the Vickers indenter of a hardness tester is inserted to 0.3 μm from the surface of Example 5; and

FIG. 4 is a graph which shows the relationship between load (mN) and the indentation depth when the tip of the Vickers indenter of a hardness tester is inserted to 0.3 μm from the surface of Reference Example 6.

### DESCRIPTION OF EMBODIMENTS

Hereinafter, the present invention is described in further detail. The composition for forming a glass film used in the present invention contains polysilazane and a diluting solvent as essential components. The polysilazane includes repeated units represented by the structural formula (1) below and it is possible to exemplify those soluble in a solvent.

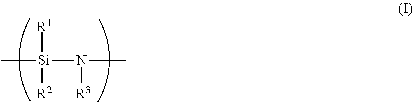

Furthermore, in the above formula, R¹, R² and R³ each represent any one of a hydrogen atom, an alkyl group, an alkenyl group, a cycloalkyl group, an aryl group, or a group where the group which kinks directly to a silicon is carbon, an alkyl silyl group, an alkyl amino group, and alkoxyl group. However, at least one of R¹, R² and R³ is the hydrogen atom.

As the polysilazane, polysilazane formed from just hydrogen (H) which is any one of R¹, R² and R³, that is, a straight chain structure in which the structure units shown in the structural formula (II) below are repeated does not include organic groups. Therefore, when forming a silica glass protective film, it is easy to from a silica glass with a high purity without fear of residual organic groups, and the polysilazane having the repeating units in the following structural formula (II) is preferably used.

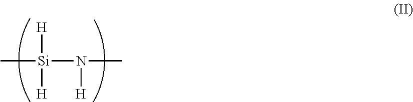

Furthermore, a polysilazane with a repeating unit of the formula (I) and (II) may be produced by any known method.

In addition, usually, the polysilazane is preferably used having a number average molecular weight in the range of 90 to 50,000. In addition, the polysilazane is preferably used in the range of 30 wt % to 42 wt % with respect to the total weight of the composition for forming a glass film used in the present invention.

Furthermore, anything can be used as the dilution solvent used in the coating solution of the present invention as long as it can be dissolved and is of any solvent which is not easily soluble in water. In addition, when considering storage stability, it is preferable that those having a continuous solvent power with respect to polysilazane, and even during long-term use, a solvent which is stable without the occurrence of a gas such as silane, hydrogen, and ammonia is preferred.

Polysilazane with a repeating unit having the structural formula (I) above is hydrolyzed to silicon dioxide as shown in the reaction formula below

SiH₂NH+2H₂O→SiO₂+NH₃+2H₂

As described above, the repeating unit parts represented by the structural formula (I) above form a three-dimensional network structure of silicon dioxide polymerized by the existence of water, and form a protective film comprised of a glass film that covers the surface of the noble metal base. Therefore, it is preferable to avoid water being mixed in the composition for forming the glass film before the composition for forming the glass film is coated onto the surface of the noble metal base.

From this point of view, it is possible to exemplify petroleum solvents such as mineral spirits, paraffinic solvents, aromatic solvents, cycloaliphatic solvents, ethers and halogenated hydrocarbons as the diluent solvent. Examples of these solvents or the components of these solvents, include for example C8 octane, 2,2,3-trimethyl pentane, C9 nonane, 2,2,5-trimethyl hexane, C10 decane, and C11 n-undacane as the paraffinic solvent component, and as the aromatic solvent component, for example, C8 xylene, C9 cumene, mesitylene, C10 naphthalene, tetrahydronaphthalene, butylbenzene, p-cymene, diethyl benzene, tetramethylbenzene, and C1 pentylbenzenem, and as the cycloaliphatic solvent component for example, C7 methyl cyclohexane, C8 ethyl cyclohexane, C10 p-menthane, α-pinene, dipentene, and decalin, and as an ether, for example, dimethyl ether, diethyl ether, dibutyltin ether, polyglycol ether, and tetrahydrofuran, and as a halogenated hydrocarbon for example, dichloromethane, dichloroethane, chlorinated hydrocarbon such as chloroform or a corresponding fluorinated brominated or iodinated hydrocarbon, and chlorinated aromatic compounds such as chlorobenzene and the like. Furthermore, it was found that a terpene mixture, for example, using Depanol® as a solvent is also effective. Furthermore, each of these solvents is illustrated only for reference, and a solvent or component or the solvent are not specifically limited to these examples. These solvents or solvent components can be used alone or in a mixture. Mineral spirits, paraffin solvent, dibutyl ether and the like are particularly preferred as these solvents.

Furthermore, dehydrogenation, a palladium compound which is an oxidation catalyst and an amino catalyst which promotes a reaction with water have the effect of reducing the temperature for converting the polysilazane to silica. However, there is a risk that impurities remaining in the protective film may denature the surface of the alloy and thus lose aesthetic characteristics in the case where the Au—Al alloy is used as the noble metal base. Thus, in the case where a Au—Al alloy is used the noble metal base, in order to form a protective film of high purity silicon dioxide, the composition for forming the glass film is preferred to not include a catalyst component which converts polysilazane to silica.

As described above, a composition for forming a glass film prepared so that it does not contain a catalyst component which converts polysilazane to silica glass is excellent in the ability to protect the surface state of the Au—Al alloy. In addition, the compound for forming a glass film which does not include the catalyst component has sufficient durability for distributing the Au—Al alloy as jewelry. Furthermore, a composition for forming a glass film not containing the catalyst component but containing gold and aluminum in the range of 16.0 wt % to 22.0 wt % and 76 wt % to 82 wt % is preferably applied as the Au—Al alloy including a purple color

In addition, with the purpose of avoiding water being is mixed into the composition for forming a glass film that is used in the present invention, it is preferred that the composition for forming a glass film not be exposed to air until the process of forming a coating film of the composition for forming a glass film on the surface of the noble metal base is completed. For example, among the instruments and devices used as a means for coating the composition for forming a glass film, it is preferred that parts which contact with the composition for forming a glass film and the composition for forming a glass film are held in a dry state inert atmosphere as much as possible.

More specifically, if the container storing the composition for forming a glass film is placed in a glove box and as much as possible the interior of the glove box is replaced with an inert gas such as dried nitrogen, argon or a mixed gas such as nitrogen and argon, the composition for forming a glass film does not deteriorate within the container and the liquid surface does not harden. Therefore, if there is an environment substituted with an inert gas, it is possible to maintain a uniform quality of the composition for forming a glass film exposed to the exterior of a storage container during and before and after the process of coating on the surface of each noble metal base even in the case of coating the composition for forming a glass film on the surface of a plurality of noble metal bases.

A silver based alloy has a risk of discoloration at a temperature of 150° C. to 200° C. Therefore, it is preferred to add a fine amount of palladium to the composition for forming a glass film as a catalyst component, and after coating the composition for forming a glass film on a silver based alloy in an inert gas atmosphere, exposing to air and drying and hardening the composition for forming a glass film at room temperature. The upper limit temperature in the case where a silver based alloy coated with the composition for forming a glass film is to be heated is preferred to be 100° C. Furthermore, in the case where a liquid state silver based alloy coated with a composition for forming a glass film is stored at room temperature, it is necessary to expose the alloy to air for 3 days or more, and more preferably for 7 days or more. When the liquid state silver based alloy coated with a composition for forming a glass film is exposed for 3 days or less, the coated composition for forming a glass film can be easily peeled off from the surface of the silver based alloy and does not have the desired strength.

Even if the added amount of palladium is sufficient at a small amount, for example, a contained amount of 100 ppm or less in the composition for forming a glass film, hardening of the composition for forming a glass film is accelerated and a strength sufficient can be obtained for protecting the surface of a silver based alloy on the base from contact with nails or coins.

The prepared composition for forming a glass film is coated to the top of a noble metal base in an inert gas atmosphere. Coating to the base maybe performed one time or repeatedly. Although the noble metal base coated with the composition for forming a glass film is not particularly limited, a noble metal base having a surface that is easily discolored when exposed to air, for example, is suitably used for a silver based alloy and gold based alloy.

In addition, a usual coating method, that is, a spin coating method, a dip method, a spraying method, a transfer method, or a method known for coating liquids can be used as the coating method. However, a film thickness amount after hardening of the silica glass film so that a protective film of about 0.2 μm to 1.0 μm is formed on the surface of the noble metal base is preferred. In order to form this film thickness, the coating method is determined by taking into account conditions such as the surface shape of the noble metal base and size.

As the concentration of polysilazane becomes higher, the viscosity of the composition for forming a glass film increases. Therefore, in the case of using a composition for forming a glass film which contains 40 wt % by weight or more of the polysilazane, it is possible to coat polysilazane at an amount capable of forming a protective film of about 0.2 μm to 1.0 μm just by coating the composition for forming a glass film once. On the other hand, it is difficult to coat uniformly on the surface of the noble metal base due to high viscosity, and the coating state of the polysilazane may become uneven.

On the other hand, when the concentration of the polysilazane becomes low, the amount of polysilazane which can be coated on the surface of the noble metal base at one time is reduced, however it is possible to increase the thickness of a protective film to be finally formed by increasing the number of coatings. However, when the concentration of the polysilazane is too low, it is not possible to achieve an increase in film thickness even if the number of coatings is increase. Furthermore, the coating state of the polysilazane may not be uniform due to the viscosity of the composition for forming a glass film.

In order to form a protective film of uniform thickness based on the viewpoint described above, it is preferred to coat the composition for forming a glass film containing the polysilazane in the range of 34 wt % to 36 wt % two or more times on the surface of the noble metal base.

In addition, although the surface of the noble metal base appears smooth to the naked eye, microscopically unevenness is formed. It is possible to increase adhesion of the protective film on the surface of the noble metal base by attaching the composition for forming a glass film of the above also on these uneven parts. Therefore, coating the composition for forming a glass film on the noble metal base while providing a slight vibration to the noble metal base is preferred. Furthermore, while there is no particular limitation to providing a slight vibration to noble metal base, for example, it is possible to use a ultrasound transducers. In addition, the fine vibration is preferred to be a frequency of 1 KHz to 100 MHz and an amplitude of 5 μm to 100 μm.

As described above, polysilazane which is one component of the composition for forming a glass film is hydrolyzed by water molecules. Therefore, in the case where the concentration of the polysilazane contained in the composition for forming a glass film is less than 30%, it is preferred to repeat the process of coating the composition for forming a glass film until a silica glass film having a thickness of 0.2 μm to 1.0 μm is finally formed. When the composition for forming a glass film is recoated after the start of the formation of the silica glass, there is a possibility that the protective film formed on the surface of the noble metal base becomes uneven and strength is decreased.

In the case where the noble metal base formed with a coated film of the composition for forming a glass film is an Au—Al alloy, it is preferred to bake the noble metal base under a temperature of 350° C. or less and less than the melting point of a noble metal base and in an atmosphere where water molecules such as air or atmospheric humidity exist.

Vapor pressure when baking the noble metal base is preferred to be in the vicinity of saturation vapor pressure under a baking temperature. However, while water vapor is supplied near the coating film of the composition for forming a glass film, it is possible to simultaneously supply air and remove ammonia gas or the like that occurs with the formation of the silica glass film.

Alternatively, in the baking step of coating a film on the composition for forming a glass film, while supplying water vapor it is possible to maintain a reduced pressure state using a rotary pump or the like, and remove ammonia gas or the like that occurs with the formation of the silica glass film.

Furthermore, in order to securely avoid losing the aesthetics of the surface of the noble metal base, the baking process described above is preferred to be carried out at a temperature of 350° C. or more and in a temperature range from the melting point of the noble metal base and 50° C. and with a baking time of 30 minutes to 2 hours. For example, after coating the composition for forming a glass film on the surface of the Au—Al alloy, the baking process may be performed by baking at 450° C. in a state of being held in a saturated water vapor atmosphere for about one hour.

According to the noble metal protective film described above, because a composition for forming a glass film with polysilazane as a main component is coated to the surface of a noble metal base in an inert gas atmosphere, it is possible to maintain the liquid state of the composition for forming a glass film on the surface of the noble metal base at least until the coating process is completed. Thus, by maintaining the state of the inert gas atmosphere around the noble metal base after the coating process is completed, it is possible to easily adjust the film thickness of the liquid film of composition for forming the coated glass film. Therefore, according to the method of forming the noble metal protective layer described above, it is possible to form a silica glass film having a uniform thickness and high purity in a thickness range of 0.2 μm to 1.0 μm on the surface of the noble metal base.

According to the noble metal protective film described above, a vacuum deposition apparatus such as ion plating is not required and even if a protective film formed on the surface of the noble metal base is a single composition, because it has sufficient durability and strength, extension or expansion of the scale of production is easy, and it is easy to performed rationalization of production facilities.

In addition, according to the noble metal protective film described above, it is possible to form a silica glass with a high purity on the surface of the noble metal base. This protective film has excellent durability and has a function for maintaining the aesthetics of the surface of the noble metal alloy including a noble metal base which has a surface exposed to the air and is easily discolored and aluminum such as for example a silver-based alloy and an Au—Al alloy etc.

In addition, according to the noble metal protective film described above, by vibrating the noble metal base when coating the composition for forming the glass film on the noble metal base, it is possible to attach the composition for forming the glass film to fine recesses of the surface of the noble metal base. Therefore, the protective film formed on the surface of the noble metal base described above has excellent adhesion to the surface shape of the noble metal base.

In addition, according to the noble metal protective film described above, even in the case where the composition for forming the glass film is coated to the surface a plurality of noble metal base pieces, by performing storage and coating of composition for forming the glass film under an environment substituted with an inert gas, it is possible to uniformly maintain the quality of the composition for forming the glass film exposed to the exterior of a storage container before and after the coating process and at the time of the coating process on the surface of each noble metal base. Therefore, according to the method for forming a noble metal protective film of the present invention, the even if the composition for forming the glass film described above is applied to the surface of a plurality of noble metal bases, it is possible to form a uniform silica glass film of high quality to each individual noble metal base.

In addition, according to the noble metal protective film described above, under an environment substituted with an inert gas, it is possible to easily perform a series of processes such as storage of the composition for forming the glass film, coating the composition on the surface of each noble metal base, and adjustment of the thickness of the liquid film of the composition for forming the coated glass film.

### EXAMPLES

Hereinafter, a more detailed explanation of the present invention is given by providing Example and Comparative Examples.

### (Noble Metal Base)

Sample pieces A to C of the noble metal alloy having the composition shown in Table 1 were prepared as the noble metal base. These sample pieces include a shiny purple color.

TABLE 1

Alloy Composition (wt %)

| | Gold | Aluminum | Palladium | Copper |
|---|---|---|---|---|
| Noble Metal Base | (Au) | (Al) | (Pd) | (Cu) |
| Test Sample A | 79.5 | 20.0 | 0.30 | 0.20 |
| Test Sample B | 79.8 | 19.5 | 0.35 | 0.35 |
| Test Sample C | 80.0 | 19.4 | 0.30 | 0.30 |

### (Composition for Forming a Glass Film)

According to the present invention, the composition for forming a glass film used when forming a protective film on the surface of the test pieces A to C was prepared according to the composition shown in Table 2. Furthermore, the polysilazane to be used and has no organic group, that is, one with a straight chain structure in which structural units represented by the structure formula (II) is repeated.

TABLE 2

| | |
|---|---|
| Composition for | Components (wt %) |

| Forming a Glass Film | polysilazane | butylbenzene |
|---|---|---|
| Coating Solution 1 | 38 | 62 |
| Coating Solution 2 | 34 | 66 |
| Coating Solution 3 | 32 | 68 |

### Example 1

Each of the test samples A to C were dipped in a liquid state composition for forming a glass film prepared using the composition of coating solution 1 in Table 2 within a glove box substituted with dry argon and thereby the composition for forming a glass film was coated onto the surface of the test pieces A to C. Next, the film thickness of the liquid shaped film was uniformly prepared so that unevenness on the liquid shape film formed on the surface of each of the test samples A to C were removed.

Following this, the test samples A to C were removed from the glove box, the test samples A to C were baked using an electric furnace for 1 hour at 450° C. under atmospheric pressure, then cooled and the noble metal protective films (1)-1, (1)-3 and reference example (1)-2 of Example 1 were obtained. Furthermore, dipping of the test samples A to C in the coating solution 1 was performed in a state where the test samples A to C were applied with a slight vibration. In addition, a 200 ml beaker filled with 100 ml of water was set in a sample chamber of the electric furnace with the test samples A to C and heated and thereby an atmosphere in which water vapor exists under a baking temperature was realized within the test chamber. The noble metal protective film (1)-1 and (1)-3 and the reference example (1)-2 were measured for Martens hardness and Vickers hardness using a hardness tester “PICODENTOR HM500” (manufactured by Fisher Co.) in a General Machinery Foundation Association for the Advancement of technology Research Room. Furthermore, when measuring hardness, Martens hardness (HM) and Vickers hardness (HV) were measured by applying the test conditions of test load 500 mN and 5 mN and load holding period of 5 seconds. The results are shown in Table 3.

TABLE 3

| Noble Metal | | | Composition | | Film |
|---|---|---|---|---|---|
| Protective | | | for Forming | | Thickness of |
| Film | HM | | a Glass | Number of | Protective |
| (Example 1) | [N/mm²] | HV | Film | Coatings | Film [μm] |
| (1)-1 | 2352.2 | 351.6 | Coating | 1 | 0.2~0.9 |
| (1)-2 | 2167.3 | 323.4 | Solution 1 | | |
| (Reference | | | | | |
| Example) | | | | | |
| (1)-3 | 2284.1 | 328.7 | | | |
| Average | 2267.8 | 334.6 | | | |
| Value | | | | | |

### Example 2

Except for using the coating solution 2 of Table 2 as the composition for forming a glass film, noble metal protective films (2)-1, (2)-2 and (2)-3 of Example 2 were obtained under the same conditions as in Example 1. Martens hardness (HM) and Vickers hardness (HV) of the protective films were measured under the same conditions as Example 1. The results are shown in Table 4.

TABLE 4

| Noble Metal | | | Composition | | Film |
|---|---|---|---|---|---|
| Protective | | | for Forming | | Thickness of |
| Film | HM | | a Glass | Number of | Protective |
| (Example 2) | [N/mm²] | HV | Film | Coatings | Film [μm] |
| (2)-1 | 2521.4 | 371.4 | Coating | 1 | 0.2~0.3 |
| (2)-2 | 2548.9 | 347.1 | Solution 2 | | |
| (2)-3 | 2514.9 | 390.2 | | | |
| Average | 2528.4 | 369.6 | | | |
| Value | | | | | |

### Example 3

Except for using the coating solution 2 of Table 2 as the composition for forming a glass film and coating two times, noble metal protective films (3)-1, (3)-2 and (3)-3 of Example 3 were obtained under the same conditions as in Example 1. Martens hardness (HM) and Vickers hardness (HV) of the protective films were measured under the same conditions as Example 1. The results are shown in Table 5.

TABLE 5

| Noble Metal | | | Composition | | Film |
|---|---|---|---|---|---|
| Protective | | | for Forming | | Thickness of |
| Film | HM | | a Glass | Number of | Protective |
| (Example 3) | [N/mm²] | HV | Film | Coatings | Film [μm] |
| (3)-1 | 2209.9 | 342.1 | Coating | 2 | 0.8~0.9 |
| (3)-2 | 2207.1 | 342.3 | Solution 2 | | |
| (3)-3 | 2196.3 | 338.6 | | | |
| Average | 2204.4 | 341.0 | | | |
| Value | | | | | |

### Example 4

Except for using the coating solution 3 of Table 2 as the composition for forming a glass film and coating two times, noble metal protective films (4)-1, (4)-2 and (4)-3 of Example 4 were obtained under the same conditions as in Example 1. Martens hardness (HM) and Vickers hardness (HV) of the protective films were measured under the same conditions as Example 1. The results are shown in Table 6.

TABLE 6

| Noble Metal | | | Composition | | Film |
|---|---|---|---|---|---|
| Protective | | | for Forming | | Thickness of |
| Film | HM | | a Glass | Number of | Protective |
| (Example 4) | [N/mm²] | HV | Film | Coatings | Film [μm] |
| (4)-1 | 2618.8 | 399.0 | Coating | 2 | 0.2~0.5 |
| (4)-2 | 2469.6 | 402.3 | Solution 3 | | |
| (4)-3 | 2598.9 | 406.5 | | | |
| Average | 2562.4 | 402.6 | | | |
| Value | | | | | |

### Comparative Examples 1-3

Noble metal protective films of Comparative Examples 1-3 were obtained by natural drying in air after coating the surface of each test sample A to C in Table 1 using a commercially available resin coating. Martens hardness (HM) and Vickers hardness (HV) of the Comparative Examples were measured under the same conditions as Example 1. The results are shown in Table 7.

TABLE 7

| Noble Metal Protective | HM | | Composition for |
|---|---|---|---|
| Film | [N/mm²] | HV | Forming a Film |
| Comparative Example 1 | 175.8 | 19.4 | Resin Coating |
| Comparative Example 2 | 182.4 | 19.8 | Agent |
| Comparative Example 3 | 181.4 | 19.8 | |

### Comparative Examples 4-6

Noble metal protective films of Comparative Examples 4-6 were obtained by natural drying in air after coating the surface of each test sample A to C in Table 1 using a water glass coating agent. Martens hardness (HM) and Vickers hardness (HV) of the Comparative Examples were measured under the same conditions as Example 1. The results are shown in Table 8.

TABLE 8

| Noble Metal Protective | HM | | Composition for |
|---|---|---|---|
| Film | [N/mm²] | HV | Forming a Film |
| Comparative Example 4 | 252.5 | 27.8 | Water Glass |
| Comparative Example 5 | 259.1 | 28.6 | Coating Agent |
| Comparative Example 6 | 259.0 | 28.7 | |

### Reference Examples 1-3

Vickers hardness (HV) at 3 arbitrary points (X1, X2, X3) on the surface of each of the test sample A to C in Table 1 were measured under the same conditions as Example 1. The results are shown in Table 9.

TABLE 9

| | HV | | | Average |
|---|---|---|---|---|
| | X₁ | X₂ | X₃ | Hardness |
| Test Sample A | 218 | 216 | 224 | 219.3 |
| Test Sample B | 213 | 220 | 215 | 216.0 |
| Test Sample C | 221 | 204 | 213 | 212.7 |

Vickers hardness of the protective films in Examples 1-4 and films in Comparative Examples 1-6 and average hardness of test samples A to C based on Tables 3 to 9 are summarized Table 10.

TABLE 10

| | Test | Test | Test |
|---|---|---|---|
| | Sample A | Sample B | Sample C |
| Example 1 | 1.60 | 1.50 | 1.54 |
| | | (Reference Example) | |
| Example 2 | 1.69 | 1.61 | 1.83 |
| Example 3 | 1.56 | 1.58 | 1.59 |
| Example 4 | 1.82 | 1.86 | 1.91 |
| Comparative Example 1 | 0.09 | — | — |
| Comparative Example 2 | — | 0.09 | — |
| Comparative Example 3 | — | — | 0.09 |
| Comparative Example 4 | 0.13 | — | — |
| Comparative Example 5 | — | 0.13 | — |
| Comparative Example 6 | — | — | 0.13 |

From Table 10, according to the present invention, it can be seen that it is possible to protect the surface of a noble metal with a coating film (328HV to 400HV) having a higher hardness than the noble metal. In contrast, the hardness of a conventional coating film, for example a film formed using a polymer resin or the like as a resin coating is less than 20HV as is shown in Comparative Examples 1-3 and is less than 1/16 of the hardness of the coating film formed by the present invention. In this way, a conventional coating film does not meet the needs in terms of hardness, a friction coefficient is high, is easy to damage and lacks abrasion resistance.

In addition, it is difficult to prevent discoloration in the case of using a polymer resin. Other than this, although it is possible to conceive of diamond-like coatings, because the cost is extremely high, it is necessary to make the film thickness of the coating film extremely thin, and in order to achieve this, the thickness must be a level which allows oil to pass through and the cost effects can not be expected.

However, since a noble metal protective film formed by the present invention is composed from high purity silicon oxide, durable is high and the surface of the noble metal is never discolored. In order to confirm the discoloration prevention of the noble metal protective layer according to the present invention function of the noble metal protective film by the present invention, the following experiment was conducted for the same Au—Al alloy which is not coated at all, one which is coated 100 times and in the case of a noble metal protective film via the present invention.

### (Acid Resistance Test to Prevent Discoloration)

First, in the case of an alloy composed mainly of an Au—Al alloy without any coating, when immersed for 24 hours in a strong 1.13 pH dilute sulfuric acid, purple color disappeared completely and changed to the color of a platinum group.

In addition, also in the case of hundred coats, when immersed for 24 hours in a strong 1.13 pH dilute sulfuric acid, the purple color disappeared completely and changed to the color of a platinum group.

However, in the case when it has a noble metal protective film via the present invention, the color did not change at all even when immersed for 24 hours in a strong 1.13 pH dilute sulfuric acid.

### (Alkali Resistance Test to Prevent Discoloration)

First, in the case of an alloy composed mainly of an Au—Al alloy without any coating, just by immersing for 2 hours in a strong alkali 12.8 pH die cleaner, the purple color disappeared completely and changed to the color of a platinum group.

Next, even in the case of hundred coats, when immersed for 24 hours in a strong alkali 12.8 pH die cleaner, the purple color disappeared completely and changed to the color of a platinum group.

However, in the case when it has a noble metal protective film via the present invention, the color did not change at all even when immersed in a strong alkali 12.8 pH die cleaner for 24 hours. In this way, a noble metal protective film formed by the present invention has extremely high acid resistance and resistance to alkali, and it is possible to prevent discoloration.

As described above, the noble metal protective film formed via the present invention, has an extremely high resistance against discoloration and it is possible to maintain the film state of the coat material itself for a long time with almost no discoloration. On the other hand, in the case of no coats or hundred coats, there is only low tolerance to discoloration. Furthermore, in the case of hundred coats, the coats peel off in about one month in normal usage conditions and the coating peels off earlier due to wear in particular and the like.

In particular, in the case of hundred coats, resistance against real not artificial sweat of real people is low, for example in the case of performing hundred coats on a ring of Au—Al alloy, the coating peels in several days due to sweat and was practicality extremely poor.

In the case of no coating, rust may occur as well as discoloration in 2 to 3 days due to real not artificial human sweat and dirt. In particular, discoloration when using so-called purple gold must not occur considering the decorative value of an ornament etc. and those that change color can not be practically used.

### Example 5

### (Composition for Forming a Glass Film)

A composition for forming a glass film (coating solution 4) used in forming a protective film on the surface of the test samples A to C described above according to the present invention were prepared according to the composition in Table 11. Furthermore, the polysilazane to be used and has no organic group, that is, one with a straight chain structure in which structural units represented by the structure formula (II) is repeated. Furthermore, the coating solution 4 contains a fine amount of palladium.

TABLE 11

| Composition for | Components (wt %) | | |
|---|---|---|---|
| Forming a Glass Film | Polysilazane | Butylbenzene | Palladium |
| Coating solution 4 | 38 | 62 | fine amount |

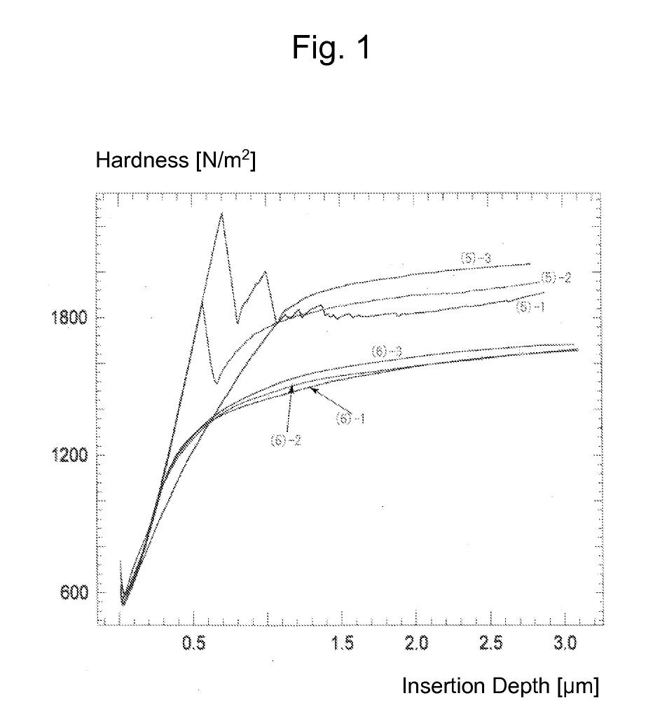

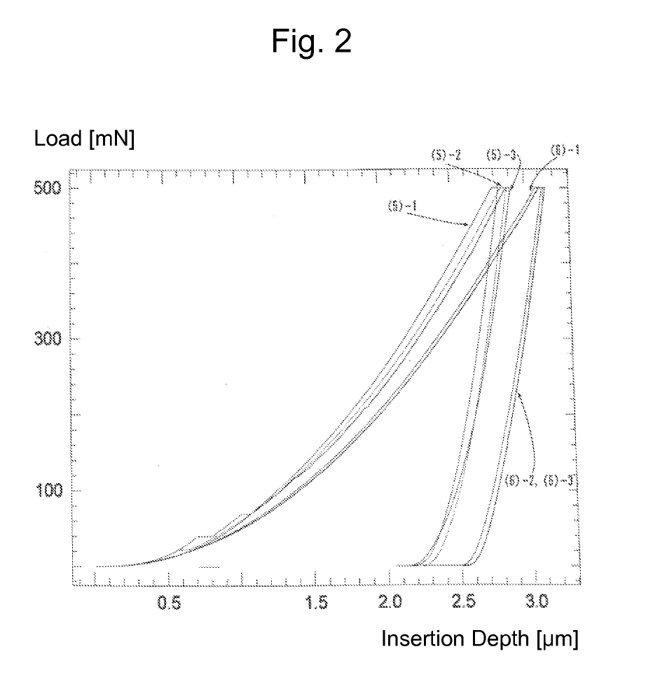

Each of the test samples A to C in Table 1 were dipped in the liquid state composition for forming a glass film manufactured by the composition of the coating solution 4 and thereby this composition for forming a glass film was coated on the surface of the test samples A to C under the conditions in Table 12. Following this, the coated surface was exposed to air for 7 days and the noble metal protective films (5)-1 to (5)-3 in Example 5 were obtained. Martens hardness (HM) and Vickers hardness (HV) of Examples 5 were measured under the same conditions as Example 1. The results are shown in Table 12 and in FIG. 1 and FIG. 2.

TABLE 12

| Noble Metal | | | Composition | | Film |
|---|---|---|---|---|---|
| Protective | | | for Forming | | Thickness of |
| Film | HM | | a Glass | Number of | Protective |
| (Example 5) | [N/mm²] | HV | Film | Coatings | Film [μm] |
| (5)-1 | 1108.1 | 190.0 | Coating | 1 | 0.5~1.0 |
| (5)-2 | 1096.1 | 191.8 | Solution 4 | | |
| (5)-3 | 1108.4 | 196.9 | | | |
| Average | 1104.2 | 192.9 | | | |
| Value | | | | | |

### Reference Example 6

Instead of the test samples A to C in Table 1, test samples D to F of a silver-based alloy called sterling silver were prepared. Furthermore, among, the sterling silver components described here, the silver component is 92.5 wt % with the rest mainly including copper and a small amount of aluminum.

Using the coating solution 4 as the composition for forming a glass film, noble metal protective films (6)-1 to (6)-3 of Example. 6 were obtained by applying each of the same production conditions in Example 5 to each of the test samples D to F. Martens hardness (HM) and Vickers hardness (HV) of Reference Example 6 were measured under the same conditions as Example 1. The results are shown in Table 12 and in FIG. 1 and FIG. 2. Furthermore, because the HM measurement value and HV measurement value of Reference Examples (6)-2 and (6)-3 are approximately equivalent, the graph curves of these data shown in FIG. 2 substantially overlap.

TABLE 13

| Noble Metal | | | Composition | | Film |
|---|---|---|---|---|---|
| Protective | | | for Forming | | Thickness of |
| Film | HM | | a Glass | Number of | Protective |
| (Example 6) | [N/mm²] | HV | Film | Coatings | Film [μm] |
| (6)-1 | 1095.8 | 188.8 | Coating | 1 | 0.5~1.0 |
| (6)-2 | 1088.6 | 190.5 | Solution 4 | | |
| (6)-3 | 1102.1 | 190.1 | | | |
| Average | 1095.5 | 189.8 | | | |
| Value | | | | | |

After measuring the hardness described above, it was confirmed that peeling and the like did not occur when he coating film of Example 5 and Reference Example 6 were visually observed. From this fact, it was clear that the coating film of Example 5 and Reference Example 6 include a function that prevents damage to the base noble metal surface due to nails corresponding to a Vickers hardness of HV70 to 120 and contact with 10 yen coins corresponding to a Vickers hardness of HV150 to 180.

### (Stability Test of Mechanical Strength of a Protective Film)

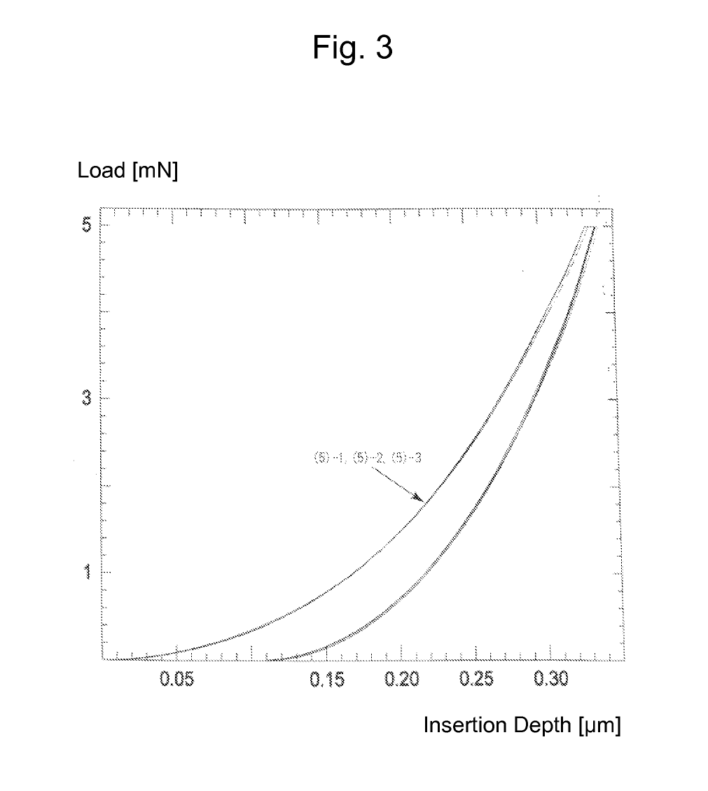

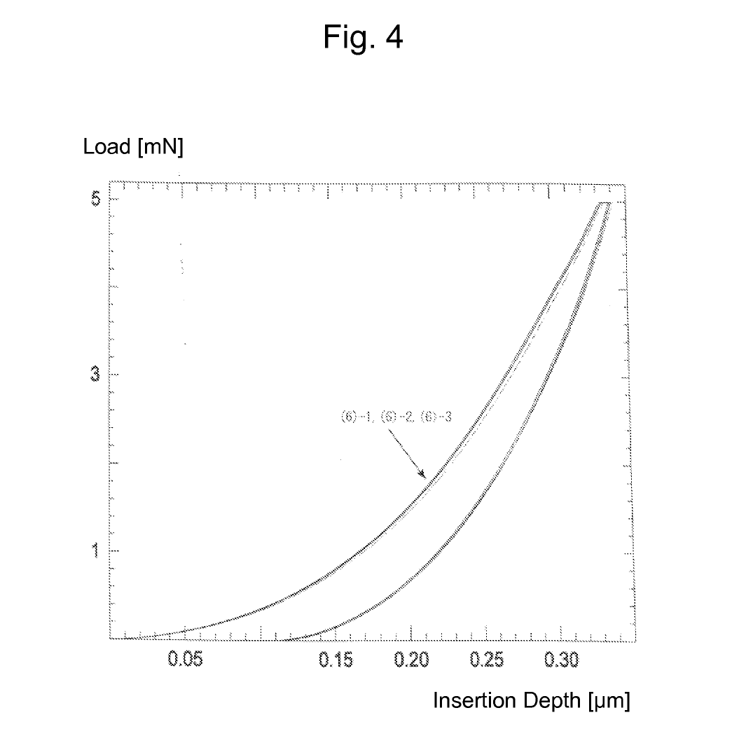

A Vickers indenter which is the end portion of a hardness tester was inserted into the surface of each protective film of Example 5 and Reference Example 6 to 0.3 μm from the surface and the relationship between the indentation depth and the indentation load was examined. These results are shown in FIG. 3 and FIG. 4. As can be seen from FIG. 3 and FIG. 4, the HM measurement value and HV measurement value of Examples (5)-1 to (5)-3 and Reference Examples (6)-1 to (6)-3 are approximately equivalent. The graph curves of the actual measurement data of the Examples (5)-1 to (5)-3 in FIG. 3 substantially overlap and the graph curves of the actual measurement data of the Examples (6)-1 to (6)-3 in FIG. 4 also substantially overlap. That is, a similar performance is shown regardless of the material of the base noble metal in the region of about a depth of 0.3μ. From these results it can be seen that it is possible to form a protective film including stable mechanical strength on the surface of the noble metal using the formation process of a noble metal protective film of the present invention.

As described above, according to the present invention, it is possible to support an Au—Al alloy having a substantially purple color over a long period in a stable state, and it is possible to use this alloy in various noble metal ornaments. That is, other than those products using the alloy itself, it is possible to use this alloy in jewelry such as rings, necklaces, bracelets, brooches, tie pins and cufflinks, etc., and also in various products such as clocks and glasses. Alternatively, the alloy can also be used for decorations such as ornaments and the like.

Therefore, it is possible to use the method of forming a noble metal protective film of the present invention for part or all rings and the chain portion of necklaces. In this way, the according to the present invention, it is possible to form a silica glass film which effectively protects alloys having a purple color or the decorative value of a noble metal with high aesthetics over a long period of time on the surface of the noble metal.

What is claimed is:

1. A noble metal protective film formed by coating a composition for forming a liquid glass film containing polysilazane as a main component on a surface of a noble metal base, consisting of a silica glass film formed on a surface of the noble metal base by hydrolysis of a coating film comprised from the composition for forming a glass film;
wherein
the noble metal base is an Au—Al alloy containing gold and aluminum with gold in the range of 78 wt % to 80 wt % and aluminum in the range of 18 wt % to 21 wt %; and
the silica glass film has a film thickness of 0.2 μm to 1.0 μm, and a Vickers hardness of 328.7 (HV) or more.

2. The noble metal protective film according to claim 1, wherein the composition for forming a glass film is coated on the surface of the noble metal base in an inert gas atmosphere.

3. The noble metal protective film according to claim 1, wherein the noble metal base formed with a coating layer comprised from the composition for forming a glass film is held in an atmosphere containing water vapor.

4. The noble metal protective film according to claim 2, wherein the inert gas is argon gas.

5. The noble metal protective film according to claim 1, wherein coating the composition for forming a glass film on the Au—Al alloy is performed by dipping a surface of an ornament comprised from the Au—Al alloy in the liquid composition for forming a glass film.

6. The noble metal protective film according to claim 1, wherein hydrolysis of the coating film in silicon dioxide is performed by holding the noble metal base under a temperature less than the melting point of a noble metal base formed with a coating film comprised from the composition for forming a glass film.

7. The noble metal protective film according to claim 1, wherein the holding temperature is 350° C. or less.

8. A method of forming a noble metal protective film comprising:
coating a liquid composition for forming a glass film containing polysilazane as a main component on a surface of a noble metal base in an inert gas atmosphere; and
holding the noble metal base under a temperature less than the melting point of a noble metal base formed with a coating film comprised from the composition for forming a glass film, and forming a silica glass film having a film thickness of 0.2 μm to 1.0 μm;
wherein
the composition for forming a glass film does not include a catalyst component which converts polysilazane to silica glass and contains the polysilazane in the range of 30 wt % to 42 wt %;
the noble metal base is an Au—Al alloy containing gold and aluminum with gold in the range of 78 wt % to 80 wt % and aluminum in the range of 18 wt % to 21 wt %;
the holding temperature is 350° C. or less; and
the silica glass film has a Vickers hardness of 328.7 (HV) or more.

9. The method of forming a noble metal protective film according to claim 8, wherein coating the composition for forming a glass film on the Au—Al alloy is performed by dipping a surface of an ornament comprised from the Au—Al alloy in the liquid composition for forming a glass film.

10. The method of forming a noble metal protective film according to claim 8, wherein the inert gas is argon gas.
